(19) United States
(12) Patent Application Publication
(10) Pub. No.: US 2024/0145867 A1
(43) Pub. Date: May 2, 2024

(54) SEPARATOR FOR LITHIUM BATTERY AND METHOD FOR MANUFACTURING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); CHENG-HUNG CHEN, TAIPEI (TW); LI-TING WANG, New Taipei City (TW)

(21) Appl. No.: 18/097,534

(22) Filed: Jan. 17, 2023

(30) Foreign Application Priority Data
Oct. 28, 2022 (TW) 111141036

(51) Int. Cl. H01M 50/451; H01M 10/052; H01M 50/403; H01M 50/417; H01M 50/457; H01M 50/491

(52) U.S. Cl. CPC H01M 50/451; H01M 10/052; H01M 50/403; H01M 50/417; H01M 50/457; H01M 50/491

(57) ABSTRACT

A separator for a lithium battery and a method for manufacturing the same are provided. The separator includes a substrate layer and a coating layer. The substrate layer is a polyolefin porous film and has a substrate thickness ranging from 10 to 30 micrometers. The coating layer is coated on the substrate layer, and has a coating layer thickness ranging from 1 to 5 micrometers. The coating layer includes a heat-resistant resin material and a plurality of inorganic ceramic particles glued in the heat-resistant resin material. The heat-resistant resin material has a melting point (Tm) or a glass transition temperature (Tg) of not less than 150° C. An average particle size of the inorganic ceramic particles is 10% to 40% of the coating layer thickness of the coating layer. The inorganic ceramic particles are stacked in the coating layer with a height of at least three layers.

### CROSS-REFERENCE TO RELATED PATENT APPLICATION

This application claims the benefit of priority to Taiwan Patent Application No. 111141036, filed on Oct. 28, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a separator, and more particularly to a separator for a lithium battery and a method for manufacturing the same.

### BACKGROUND OF THE DISCLOSURE

The structure of a lithium battery generally includes a positive electrode material, a negative electrode material, an electrolyte, and a separator. The separator is usually placed between the positive electrode material and the negative electrode material, and plays the role of separating electrons to prevent a short circuit between the positive and negative electrodes. The separator also uses its microporous structure to conduct positively charged lithium ions in the electrolyte. Therefore, the characteristics of the separator have a great influence on the performance of the battery, which can be reflected by the energy density, power density, cycle life, and safety performance of the battery.

In the related art, most separators for lithium batteries are polyolefin separators and mainly made of polyethylene (PE), polypropylene (PP) or polypropylene/polyethylene/polypropylene (PP/PE/PP), which has a certain level of mechanical strength, chemical stability, and high porosity for absorbing electrolyte to maintain high ion conductivity. In addition, considering the safety of the battery, the heat resistance of the separator is also extremely important. The separator must be able to activate the cell closure mechanism to prevent the battery from exploding due to thermal runaway caused by a short circuit when the battery temperature rises.

Currently, the PE film activates the cell closure mechanism at about 130° C., while the PP film maintains the mechanical strength and dimensional stability at a temperature below 165° C. However, the disadvantages of the two films are low porosity, poor wettability to some electrolytes, and the thermal stability is limited to below 165° C.

Therefore, adding chemical substances to the separator for modification to improve the mechanical properties and thermal stability of the separator is the focus of future development.

Existing heat-resistant separators are mostly coated with a layer of ceramic layer (such as that made of aluminum oxide, silicon dioxide, titanium dioxide, magnesium oxide or other inorganic particles) to improve heat resistance, heat shrinkage resistance, puncture resistance, etc., so as to prevent the polyolefin film from melting and shrinking at high temperature and losing the function of blocking electrons. However, current ceramic materials have problems such as easy agglomeration and uneven dispersion, which can easily cause problems such as uneven dispersion and poor mechanical strength of the surface ceramic coating layer. In addition, ceramic materials have disadvantages such as poor adhesion to the substrate, making it easy to become detached, and low wetting ratio to the electrolyte, such that the performance and safety of lithium batteries is negatively affected.

### SUMMARY OF THE DISCLOSURE

In response to the above-referenced technical inadequacies, the present disclosure provides a separator for a lithium battery and a method for producing the same.

In order to solve the above-mentioned technical problems, one of the technical aspects adopted in the present disclosure provides a separator for a lithium battery, including: a substrate layer, wherein the substrate layer is a polyolefin porous film and has a substrate thickness ranging from 10 to 30 micrometers; and a coating layer coated on the substrate layer, wherein the coating layer has a coating layer thickness ranging from 1 to 5 micrometers; wherein the coating layer includes a heat-resistant resin material and a plurality of inorganic ceramic particles glued in the heat-resistant resin material; wherein the heat-resistant resin material has a melting point (Tm) or a glass transition temperature (Tg) of not less than 150° C., an average particle size of the inorganic ceramic particles is 10% to 40% of the coating layer thickness of the coating layer, and the inorganic ceramic particles are stacked in the coating layer with a height of at least three layers.

Preferably, in the coating layer, a content of the heat-resistant resin material ranges from 2 wt. % to 10 wt. %, and a content of the inorganic ceramic particles ranges from 80 wt. % to 96 wt. % based on the coating layer having a total weight of 100 wt. %.

Preferably, in the coating layer, the heat-resistant resin material is a water-based resin material selected from at least one material group consisting of polyvinylidene fluoride water-based emulsion, alkylamide resin, styrene-butadiene copolymer water-based emulsion, amide polyacrylic latex, polyester acrylic water-based composite resin, polyethylene glycol, polyvinyl alcohol, sodium alginate, carboxymethyl cellulose, and carboxyalkyl cellulose.

Preferably, in the coating layer, a chemical structure of the heat-resistant resin material has a hydroxyl group that is capable of generating a hydrogen bond with a surface of the inorganic ceramic particles so as to promote a dispersion of the inorganic ceramic particles in the heat-resistant resin material.

Preferably, in the coating layer, the inorganic ceramic particles are at least one selected from a material group consisting of magnesium oxide, aluminum oxide, silicon oxide, titanium dioxide, magnesium sulfate, calcium sulfate, barium sulfate, boehmite, and mica.

Preferably, a substrate porosity of the substrate layer is between 30% and 60%, a coating layer porosity of the coating layer is 45% and 55%, and a specific surface area of the inorganic ceramic particles is between 5 m²/g and 25 m²/g.

Preferably, the coating layer contains a processing aid having a trace amount, and a content of the processing aid ranges from 0.01 wt. % to 3 wt. %; wherein the processing aid is one of a wetting agent, a dispersant, and a leveling agent.

Preferably, the separator for a lithium battery includes following properties:

(1) when the coating layer is torn off in an adhesive tape test, a ceramic material is inhibited from peeling off; (2) a water contact angle of the separator is not greater than 50°; (3) a thermal shrinkage of the separator in a machine direction (MD) at 150° C. is less than 10%; (4) a coating layer porosity of the coating layer is between 45% and 55%; (5) a Gurley value (sec/10 cc air) of the separator is between 10 and 20; and (6) a thermal cell closure temperature of the separator is above 150° C.

In order to solve the above-mentioned technical problems, another of the technical aspect adopted in the present disclosure provides a method for manufacturing a separator, including: providing a substrate layer, wherein the substrate layer is a polyolefin porous film and has a substrate thickness ranging from 10 to 30 micrometers; disposing a coating liquid composition, wherein the coating liquid composition includes a solute component and a solvent component, a weight ratio of the solute component to the solvent component is between 2˜20:98˜80, and the solute component includes a heat-resistant resin material and a plurality of inorganic ceramic particles; coating the coating liquid composition on a side surface of the substrate layer; and removing the solvent component in the coating liquid composition, so that the coating liquid composition is formed as a coating layer, wherein a coating layer thickness of the coating layer ranges from 1 micron to 5 microns. The substrate layer and the coating layer jointly form a separator, and in the coating layer, the heat-resistant resin material has a melting point of not less than 150° C. or a glass transition temperature of not less than 100° C., an average particle size of the inorganic ceramic particles is 10% to 40% of the coating layer thickness of the coating layer, and the inorganic ceramic particles are stacked in the coating layer with a height of at least three layers.

One of the beneficial effects of the present disclosure is that a separator for a lithium battery provided by the present disclosure can address problems such as uneven coating of ceramic materials and poor adhesion to substrates in the related art. The present disclosure provides that adding materials such as resins and processing aids can improve the dispersibility, adhesion and heat resistance of ceramic materials to the coating layer. In addition to effectively improving the dispersion uniformity of ceramic materials and the adhesion of substrates, the present disclosure also improves the heat resistance of the separator and reduces the thermal shrinkage of the separator. Furthermore, a water-based coating provided by the present disclosure can be mixed with heat-resistant ceramics, heat-resistant and adhesive water-based resin and other media and coated on polyolefin single-layer or multi-layer porous film substrates to form a coating-type separator with uniform surface distribution and heat resistance.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a separator having a coating layer on one side thereof according to an example of the present disclosure;

FIG. 2 is a schematic diagram of the separator having the coating layer on both sides thereof according to the example of the present disclosure;

FIG. 3 is a SEM image of example 1 in the experimental data of the pre sent disclosure;

FIG. 4 is a SEM image of example 5 in the experimental data of the present disclosure; and

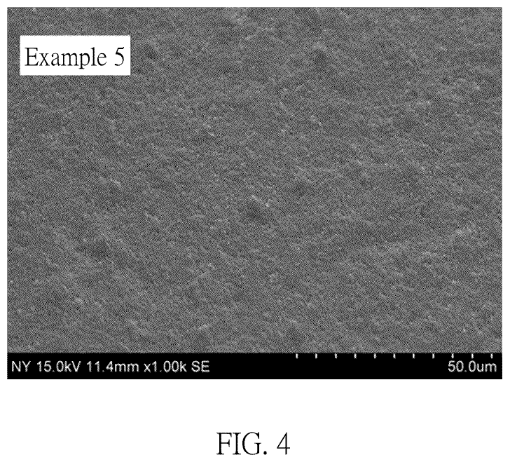

FIG. 5 is a SEM image of comparative example 1 in the experimental data of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Separator for a Lithium Battery]

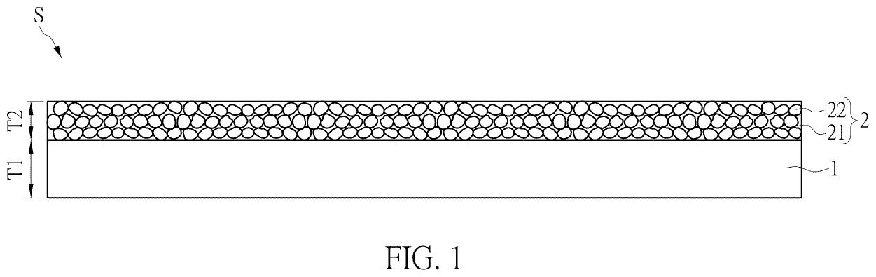

Reference is made to FIG. 1. An example of the present disclosure provides a separator S for a lithium battery. The separator S includes a substrate layer 1 and a coating layer 2 coated on the substrate layer 1.

In terms of a thickness range of the substrate layer, a substrate thickness T1 of the substrate layer 1 is between 10 microns and 30 microns, and preferably between 15 microns and 30 microns.

In terms of a material type of the substrate layer, the substrate layer 1 is a polyolefin porous film substrate, which can be, for example, a polyolefin porous film substrate with a single-layer structure or a polyolefin porous film substrate with a multilayer structure. Specifically, the substrate layer 1 can be, for example, a polyethylene (PE) porous film substrate with a single-layer structure, a polypropylene (PP) porous film substrate with a single-layer structure, or a polypropylene/polyethylene/polypropylene (PP/PE/PP) porous film substrate with a multilayer structure.

In terms of a material property of the substrate layer, a substrate porosity of the substrate layer 1 is between 30% and 60%. It should be noted that the porosity referred to in the present disclosure is a physical quantity that characterizes the pore portion of the material, which is defined as a ratio of the volume of the pores to a total volume of the material and expressed as a percentage between 0% and 100%.

Reference is further made to FIG. 1. The coating layer 2 includes a heat-resistant resin material 21 (also known as a heat-resistant adhesive) and a plurality of inorganic ceramic particles 22 adhered to the heat-resistant resin material 2.

In terms of a thickness range of the coating layer, a coating layer thickness T2 of the coating layer 2 ranges from 1 micron to 5 microns, and preferably between 1 micron and 3 microns.

In terms of a content range of each component, a content of the heat-resistant resin material 21 is between 2 wt. % and 10 wt. % (preferably 5 wt. %˜7 wt. % and particularly preferably 5.5 wt. %˜6.5 wt. %), and a content of the inorganic ceramic particles 22 is between 80 wt. % and 96 wt. % (preferably 93 wt. %˜95 wt. % and especially preferably 93.5 wt. %˜94.5 wt. %) based on the coating layer 2 having a total weight of 100 wt. %. That is to say, in this example, the content of the heat-resistant resin material 21 is lower than that of the inorganic ceramic particles 22, and the coating layer 2 uses the inorganic ceramic particles 22 as a main matrix material. The heat-resistant resin material 21 can be used to allow the inorganic ceramic particles 22 to be adhered thereto, and can be adhesion to the substrate layer 1.

In terms of a material type of heat-resistant resin, the heat-resistant resin material 21 is a water-based resin material, which can be, for example, polyvinylidene fluoride (such as: polyvinylidene fluoride homopolymer water-based emulsion or vinylidene fluoride and other water-based emulsions of copolymers containing a trace amount of fluorine-containing vinyl monomers). Alternatively, the heat-resistant resin material 21 can be, for example, at least one of alkylamide resin, styrene-butadiene copolymer water-based emulsion, amidated polyacrylic latex, and polyester acrylic water-based composite resin. Alternatively, the heat-resistant resin material 21 can be, for example, at least one of polyethylene glycol and polyvinyl alcohol. Alternatively, the heat-resistant resin material 21 can be, for example, at least one of sodium alginate, carboxymethyl cellulose, and carboxyalkyl cellulose. The above materials all have a certain degree of heat resistance and adhesiveness, and are water-based resin materials that can be dispersed in water.

It is worth mentioning that a material selection of the polyvinylidene fluoride homopolymer water-based emulsion, the vinylidene fluoride and other water-based emulsions of copolymers containing a trace amount of fluorine-containing vinyl monomers helps to increase a wetting ratio of the separator to the electrolyte. In addition, regarding a material selection of polyethylene glycol and polyvinyl alcohol, alkylamide resin and amidated polyacrylic latex, a chemical structure of the resin has a hydroxyl group (—OH), so the resin can generate a hydrogen bond with a surface of the inorganic ceramic particles, so as to promote a dispersion of the inorganic ceramic particles in the resin material.

In terms of a material property of the heat-resistant resin, the heat-resistant resin material 21 has a melting point of not less than 150° C. or a glass transition temperature of not less than 100° C. (the melting point or the glass transition temperature is preferably between 100° C. and 250° C.).

In terms of a material type of the inorganic ceramic particles, the inorganic ceramic particles 22 can be, for example, at least one selected from a material group consisting of magnesium oxide, aluminum oxide, silicon oxide, titanium dioxide, magnesium sulfate, calcium sulfate, barium sulfate, boehmite, and mica.

In terms of a material property of the inorganic ceramic particles, the materials selected for the above-mentioned inorganic ceramic particles all have heat resistance and chemical stability. It is also worth mentioning that, in order to enable the inorganic ceramic particles 22 to be uniformly dispersed in the heat-resistant resin material 21 and to exert the heat-resistant properties of ceramics, an average particle size of the inorganic ceramic particles 22 is 10% to 40% of the coating layer thickness of the coating layer 2, and preferably 10% to 30%. In some examples of the present disclosure, a specific surface area of the inorganic ceramic particles is between 5 m²/g and 25 m²/g (preferably between 5 m²/g and 15 m²/g). The shape of an appearance of the inorganic ceramic particles can be, for example, a spherical shape, a flake shape, or a specific shape such as a cuboid.

From another perspective, the inorganic ceramic particles 22 are stacked in the coating layer 2 with a height of at least three layers (as shown in FIG. 1), and are preferably stacked with a height of three to ten layers, so as to ensure that inorganic ceramic particles provide sufficient heat resistance and are not prone to chipping.

In some examples of the present disclosure, the coating layer thickness T2 of the coating layer 2 ranges from 10% to 30% of a substrate thickness T1 of the substrate layer 1, but the present disclosure is not limited thereto.

Further, the coating layer 2 also includes a processing aid having a trace amount (not shown). A content of the processing aid is between 0.01 wt. % and 3 wt. %, and preferably between 0.01 wt. % and 2 wt. %.

In terms of a material type of the processing aid, the processing aid can be, for example, at least one of a wetting agent, a dispersant, and a leveling agent.

The wetting agent can be, for example, at least one selected from a material group consisting of ethoxy acetylene, polyoxyethylene alkylphenol ether, polyoxyethylene fatty alcohol ether, and modified polyacrylate. The dispersant can be, for example, at least one selected from a material group consisting of polyacrylic acid ammonium salt, polyacrylic acid sodium salt, and alkyl alkol ammonium salt. The leveling agent can be, for example, at least one selected from a material group consisting of polyether-modified polydimethylsiloxane ether, polyacrylates, and methacrylate homopolymers or copolymers.

According to the above disposition, the separator S for a lithium battery provided by the examples of the present disclosure can solve the problems of uneven coating of ceramic materials and poor adhesion to substrates in the related art.

In addition to effectively improving the adhesion between the ceramic material and the substrate, the present disclosure provides that adding materials such as water-based resins and processing aids with adhesion and heat resistance to the coating layer can also increase the wetting ratio of the separator to the electrolyte. Furthermore, in the present disclosure, heat-resistant ceramics, heat-resistant and adhesive water-based resin and other media are mixed and coated on polyolefin single-layer or multi-layer porous film substrates to form a coating-type separator with uniform surface distribution and heat resistance.

The separator S provided by the examples of the present disclosure has the following characteristics that: (1) when the coating layer is torn off in an adhesive tape test, a ceramic material is inhibited from peeling off; (2) a water contact angle of the separator is not greater than 50°, (3) a thermal shrinkage of the separator in a MD direction at 150° C. is less than 10%; (4) a coating layer porosity of the coating layer is between 45% and 55%; (5) a Gurley value (sec/10 cc air) of the separator is between 10 and 20; and (6) a thermal cell closure temperature of the separator is above 150° C.

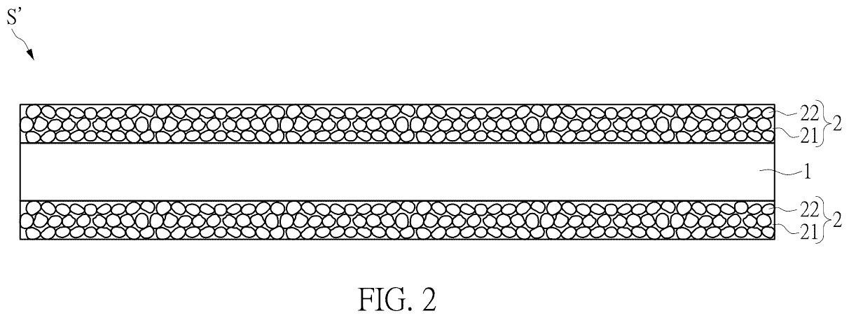

It is worth mentioning that the separator S of the examples of the present disclosure is illustrated by taking the substrate layer 1 having the coating layer 2 on one side thereof as an example, but the present disclosure is not limited thereto. In a variant example of the present disclosure, as shown in FIG. 2, the separator S′ may be, for example, the substrate layer 1 having the coating layer 2 on both sides thereof.

[Method for Manufacturing a separator]

The above is a description of the structural characteristics and material characteristics of the separator for a lithium battery of the examples of the present disclosure. The method for manufacturing a separator according to the examples of the present disclosure will be described in following paragraphs. The method for manufacturing a separator includes S110, S120, S130, and S140. It should be noted that an order of the steps and an actual operation method in this example can be adjusted according to practical requirements, and are not limited to the example.

S110 includes: providing a substrate layer, wherein the substrate layer is a polyolefin porous film substrate. A substrate thickness of the substrate layer is between 10 microns and 30 microns, and preferably between 15 microns and 30 microns. A substrate porosity of the substrate layer is between 30% and 60%.

S120 includes: disposing a coating liquid composition. The coating liquid composition comprises a solute component and a solvent component, and the solute component is dispersed in the solvent component. A weight ratio of the solute component to the solvent component is between 2-20:98-80. That is to say, a weight ratio of the solute component to the solvent component is about 2 wt. %-20 wt. %. The solute component includes: a heat-resistant resin material and a plurality of inorganic ceramic particles. A weight of the heat-resistant resin material is between 2 wt. % and 10 wt. % (preferably between 5 wt. % and 10 wt. %), and a weight of the inorganic ceramic particles is between 80 wt. % and 96 wt. % (preferably between 90 wt. % and 96 wt. %) based on the solute component having a total weight of 100 wt. %. The heat-resistant resin material is a water-based resin material and is selected from at least one of a material group consisting of polyvinylidene fluoride water-based emulsion, alkylamide resin, styrene-butadiene copolymer water-based emulsion, amide polyacrylic latex, polyester acrylic water-based composite resin, polyethylene glycol, polyvinyl alcohol, sodium alginate, carboxymethyl cellulose, and carboxyalkyl cellulose. The heat-resistant resin material has a melting point of not less than 150° C. or a glass transition temperature of not less than 100° C. (the melting point or the glass transition temperature is preferably between 100° C. and 250° C.). The inorganic ceramic particles can be, for example, at least one selected from a material group consisting of magnesium oxide, aluminum oxide, silicon oxide, titanium dioxide, magnesium sulfate, calcium sulfate, barium sulfate, boehmite, and mica.

Further, the solute component also includes a processing aid having a trace amount. An amount of the processing aid is between 0.01 wt. % and 3 wt. %, and preferably between 0.01 wt. % and 2 wt. %. According to the above disposition, the coating liquid composition has an appropriate viscosity and thus can be easily coated onto the substrate layer. Furthermore, the solvent component is an aqueous solvent. The aqueous solvent is mainly used for water-soluble polymers. The aqueous solvent is at least one selected from a material group consisting of water, methanol, ethanol, isopropanol, and ethylene glycol. The use of the water-based solvent is environment-friendly, and the cost of manufacturing process and coating is relatively low.

S130 includes: coating the coating liquid composition on one side surface of the substrate layer. The coating method employed in the example of the present disclosure is a general wet coating technology, such as: a dip coating method, a slit coating method, a gravure coating method, a spin coating method, and a polar line bar coating method, but the present disclosure is not limited thereto. If an oily solvent having high boiling point is used, the phase inversion method can be used to replace the solvent with the non-solvent (water) to prepare a thin film.

S140 includes: removing the solvent component in the coating liquid composition (such as: drying in an oven at 60° C. to 80° C.), so that the coating liquid composition is formed as a coating layer. The coating layer has a coating layer thickness ranging from 1 micron to 5 microns.

[Experimental Test Data]

Hereinafter, the content of the present disclosure will be described in detail with reference to Examples 1-5 and Comparative Examples 1-3. However, the following examples are provided only to assist in understanding the present disclosure, and the scope of the present disclosure is not limited to the se examples.

Example 1: providing a substrate layer (example 1 uses a polypropylene of single-layer structure), wherein the substrate layer has a substrate thickness of 20 microns; disposing a coating liquid composition comprising a solute component and a solvent component, wherein a weight ratio of the solute component to the solvent component is between 20 and 80; the solute component comprising a heat-resistant resin material (example 1 uses polyvinyl alcohol), inorganic ceramic particles (example 1 uses aluminum oxide) and a processing aid (example 1 uses polyacrylic acid ammonium salt), wherein the solvent component is a water and ethanol alcohol co-solvent, a proportion of water is 70%, and a proportion of alcohol is 30%; wherein a total weight of the heat-resistant resin material is 6 wt. %, a total weight of the inorganic ceramic particles is 94 wt. %, and a total weight of the processing aid is 0.01 wt. % based on the solute component having a total weight of 100 wt. % (a total weight of the following inorganic ceramic materials and the heat-resistant resin material is 100 wt. %, and an addition of the processing aid is denoted as a percentage of a total weight); coating the coating liquid composition on one side surface of the substrate layer; and removing the solvent component in the coating liquid composition, so that the coating liquid composition is formed as a coating layer having a coating layer thickness of 2 microns; wherein the substrate layer and the coating layer together form a separator. In the coating layer, the heat-resistant resin material containing polyvinyl alcohol has a melting point of 225° C., an average particle size (250 nm) of the inorganic ceramic particles is 12.5% of the coating layer thickness (2 microns) of the coating layer, and the inorganic ceramic particles are stacked in the coating layer with a height of more than three layers. The methods of Examples 2-5 and Comparative Examples 1-3 are roughly the same as that of Example 1. The main difference is that different types of heat-resistant resin materials and the usage amount are used, and the experimental conditions are described in Table 1 below.

Afterwards, the physical and chemical properties of the separators obtained in the above examples and comparative examples are tested to obtain the physical and chemical characteristics of these separators, such as: powder peeling-off of the coating layer, heat shrinkage test of the separators, heat shrinkage test, porosity test of the coating layer, Gurley value test of the separators, puncture strength test, and tensile strength test. The test methods are described below, and the results related to the test are recorded in Table 2. The test methods are described below, and the results related to the test are displayed in Table 1.

<Powder peeling-off of the coating layer>: Visually observing whether there is obvious powder peeling on the separator after coating.

<Heat shrinkage test of the separator>: The method of measuring the heat shrinkage in a MD/TD direction is that a coated sample of 7 cm*7 cm is cut and put in an oven set at 150° C., and taken out after 60 minutes and cooled for 30 minutes. A vernier caliper is employed to accurately measure a length of four sides of the coated sample to measure a dimensional stability before and after heating and to evaluate the heat resistance. The calculation formula is as follows: heating shrinkage %=((length before heating−length after heating)/length before heating)*100%.

<Porosity test of the coating layer>: A coating layer porosity of the coating layer is tested by a gas displacement true density analyzer, and the test is carried out according to ASTM C604, ASTM D2638, ASTM D4892 and ISO 5106 test methods.

<Gurley value test of the separator>: Air permeability is measured by analyzing the time for every 10 cc of air passing through the separator with a high pressure air permeability meter (High Pressure Densometers, GURLEY 4150).

<Puncture strength test>: A round-tipped needle with a diameter of 1 mm is used to puncture the separator and measure a maximum force required for the rupture of the separator. The specific test method is performed according to ASTM D3763-10 “Standard Test Method for High Speed Puncture Properties of Plastics Using Load and Displacement Sensors”.

<Tensile strength>: A universal testing machine is used for the test according to ASTM D638 test method.

<Water contact angle test> A water droplet is dropped on a surface of the separator, and an angle between the water drop and the solid surface is measured, which conforms to the ASTM D 5725-1999 (2008) specification.

TABLE 1
[Experimental conditions]

| | | | | | | | Comparative | Comparative | Comparative |
|---|---|---|---|---|---|---|---|---|---|
| Item | | Example 1 | Example 2 | Example 3 | Example 4 | Example 5 | Example 1 | Example 2 | Example 3 |
| Substrate | Type | PP | PP | PP | PP | PP | PP | PP | PP |
| | Thickness (μm) | 20 | 20 | 20 | 20 | 20 | 20 | 20 | 20 |
| Coating | Formulation | | | | | | | | |
| layer | | | | | | | | | |
| Inorganic | Type | Alumina | Alumina | Alumina | Alumina | Alumina | Alumina | Alumina | Alumina |
| ceramic | Wt. % | 94 | 94 | 94 | 94 | 94 | 90 | 96 | 94 |
| particles | Particle size (nm) | 250 | 250 | 250 | 250 | 250 | 250 | 250 | 250 |
| | Specific surface | 8 | 8 | 8 | 8 | 8 | 8 | 8 | 6 |
| | area | | | | | | | | |
| Heat- | Type | Polyvinyl | Carboxymethyl | Alkylamides | Polyester | Amidated | Polyvinyl | Polyvinyl | Polyvinylidene |
| resistant | | alcohol | cellulose | | acrylic | polyacrylic | alcohol | alcohol | fluoride |
| resin | | | | | composite | latex | | | |
| material | | | | | resin | | | | |
| | Wt. % | 6 | 6 | 6 | 6 | 6 | 10 | 4 | 6 |
| | Glass transition | | | 170 | 110 | 160 | | | |
| | temperature (° C.) | | | | | | | | |
| | Melting point (° C.) | >220.0 | >220.0 | | | | >220.0 | >220.0 | 50 |

| | |
|---|---|
| Processing | A weight percentage of dispersant is fixed at 0.01% of a total weight |
| aids | |
| | Coating layer thickness is 2 um |
| Solvent | Mixture of water and alcohol |

TABLE 2
[Test results]

| | | | | | | | Comparative | Comparative | Comparative |
|---|---|---|---|---|---|---|---|---|---|
| Item | | Example 1 | Example 2 | Example 3 | Example 4 | Example 5 | Example 1 | Example 2 | Example 3 |
| Test | Coating layer | No powder | Slight | No powder | Slight | No powder | No powder | Slight | Obvious |
| Results | powder peeling-off | peeling-off | powder | peeling-off | powder | peeling-off | peeling-off | powder | powder |
| | | | peeling-off | | peeling-off | | | peeling-off | peeling-off |
| | Separator TD heat | 0 | 0 | 0 | 0 | 0 | 0 | 0 | 0 |
| | shrinkage rate | | | | | | | | |
| | Separator MD heat | 7.8 | 8.6 | 3.9 | 6 | 3.4 | 10.2 | 8.2 | 22.5 |
| | shrinkage rate | | | | | | | | |
| | Coating layer | 52 ± 1 | 52 ± 1 | 52 ± 1 | 52 ± 1 | 52 ± 1 | 55 ± 1 | 54 ± 1 | 52 ± 1 |
| | porosity | | | | | | | | |
| | Separator Gurley | 10.7 | 10.4 | 10.5 | 10.2 | 10.3 | 11.2 | 10.3 | 10.2− |
| | value | | | | | | | | |
| | Puncture Strength | ≥750 | ≥750 | ≥750 | ≥750 | ≥750 | ≥750 | ≥750 | ≥750 |
| | (gf) | | | | | | | | |
| | MD tensile strength | ≥150 | ≥150 | ≥150 | ≥150 | ≥150 | ≥150 | ≥150 | ≥150 |
| | (MPa) | | | | | | | | |
| | Appearance under SEM | evenly | unevenly | evenly | evenly | evenly | evenly | unevenly | unevenly |
| | | dispersed | dispersed | dispersed | dispersed | dispersed | dispersed | dispersed | dispersed |
| | Water contact angle | 37.6 | 42.1 | 40.6 | 41.2 | 39.7 | 39.2 | 34.5 | — |

[Discussion of the Test Results]

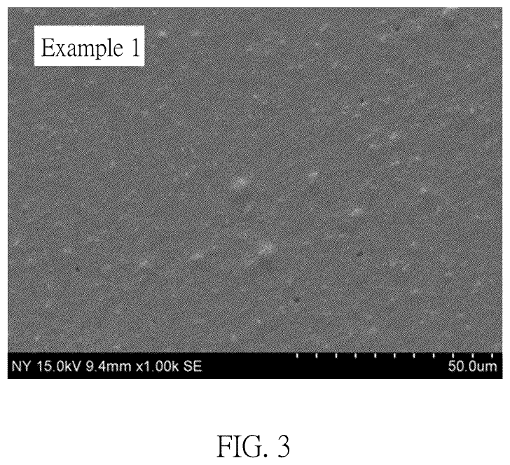

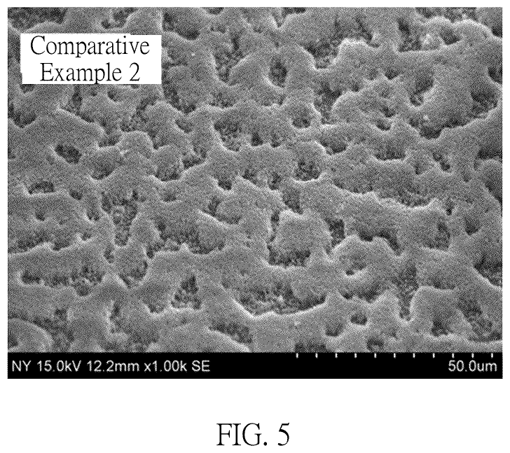

In Example 1, the heat-resistant resin material uses 6 wt. % of polyvinyl alcohol to make the ceramic material without obvious powder peeling, and the MD heat shrinkage is 7.8%. It can be known that the surface of the coating layer is evenly dispersed under the SEM image as shown in FIG. 3, so a lower heat shrinkage value is obtained compared with Comparative Example 1. In Comparative Example 2, when a proportion of polyvinyl alcohol is reduced to 4 wt. %, it can be observed that some fine powders of the ceramic material peel off, and it can be seen from the SEM image as shown in FIG. 5 that the surface of the coating layer is unevenly dispersed. It can be seen from the above results that the addition amount of polyvinyl alcohol heat-resistant resin material has the best performance in parts by weight. It can also be known from observing the addition amount of heat-resistant resin material that the air permeability value of the separator decreases as the proportion of heat-resistant resin material increases.

Examples 2 to 5 refer to the addition ratio of the thermal resin material in Example 1, and the thermal resin material is replaced with other types. It can be seen from the experimental results that the use of carboxymethyl cellulose and polyester acrylic composite resin has a weak adhesion to ceramic materials, and some fine powders peel off, but it is still within an acceptable range. The use of alkylamide resin and amidated polyacrylic latex has better adhesion to ceramic materials, and both resins have a high glass transition temperature, which can make the thermal shrinkage less than 4% for optimal effect. According to Example 5, the distribution is more uniform under the SEM image. However, the puncture strength and tensile strength are mainly affected by the properties of the substrate and the ceramic material, and do not exhibit significant difference.

### Beneficial Effects of the Embodiment

One of the beneficial effects of the present disclosure is that a separator for a lithium battery provided by the present disclosure can address the problems of uneven coating of ceramic materials and poor adhesion to substrates in the related art. The present disclosure provides that adding materials such as resins and processing aids can improve the dispersibility, adhesion and heat resistance of ceramic materials to the coating layer. In addition to effectively improving the dispersion uniformity of ceramic materials and the adhesion of substrates, it can also improve the heat resistance of the separator and reduce the thermal shrinkage of the separator. Furthermore, a novel water-based coating provided by the present disclosure can be mixed with heat-resistant ceramics, heat-resistant and adhesive water-based resin and other media and coated on polyolefin single-layer or multi-layer porous film substrates to form a coating-type separator with uniform surface distribution and heat resistance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A separator for a lithium battery, comprising:
a substrate layer, wherein the substrate layer is a polyolefin porous film and has a substrate thickness ranging from 10 to 30 micrometers; and
a coating layer coated on the substrate layer, wherein the coating layer has a coating layer thickness ranging from 1 to 5 micrometers; wherein the coating layer includes a heat-resistant resin material and a plurality of inorganic ceramic particles adhered to the heat-resistant resin material;
wherein the heat-resistant resin material has a melting point or a glass transition temperature of not less than 150° C., an average particle size of the inorganic ceramic particles is 10% to 40% of the coating layer thickness of the coating layer, and the inorganic ceramic particles are stacked in the coating layer with a height of at least three layers.

2. The separator for a lithium battery according to claim 1, wherein in the coating layer, a content of the heat-resistant resin material ranges from 2 wt. % to 10 wt. %, and a content of the inorganic ceramic particles ranges from 80 wt. % to 96 wt. % based on the coating layer having a total weight of 100 wt. %.

3. The separator for a lithium battery according to claim 1, wherein in the coating layer, the heat-resistant resin material is at least one water-based resin material selected from a material group consisting of polyvinylidene fluoride water-based emulsion, alkylamide resin, styrene-butadiene copolymer water-based emulsion, amide polyacrylic latex, polyester acrylic water-based composite resin, polyethylene glycol, polyvinyl alcohol, sodium alginate, carboxymethyl cellulose, and carboxyalkyl cellulose.

4. The separator for a lithium battery according to claim 1, wherein in the coating layer, a chemical structure of the heat-resistant resin material has a hydroxyl group that is capable of generating a hydrogen bond with a surface of the inorganic ceramic particles, so as to promote a dispersion of the inorganic ceramic particles in the heat-resistant resin material.

5. The separator for a lithium battery according to claim 1, wherein in the coating layer, the inorganic ceramic particles are at least one selected from a material group consisting of magnesium oxide, aluminum oxide, silicon oxide, titanium dioxide, magnesium sulfate, calcium sulfate, barium sulfate, boehmite, and mica.

6. The separator for a lithium battery according to claim 1, wherein a substrate porosity of the substrate layer is between 30% and 60%, a coating layer porosity of the coating layer is 45% and 55%, and a specific surface area of the inorganic ceramic particles is between 5 m²/g and 25 m²/g.

7. The separator for a lithium battery according to claim 1, wherein the coating layer contains a trace amount of a processing aid, where a content of the processing aid ranges from 0.01 wt. % to 3 wt. %, and wherein the processing aid is one of a wetting agent, a dispersant, and a leveling agent.

8. The separator for a lithium battery according to claim 1, further comprising following properties:
(1) when the coating layer is torn off in an adhesive tape test, a ceramic material is inhibited from peeling off;
(2) a water contact angle of the separator is not greater than 50°;
(3) a thermal shrinkage of the separator in a machine direction (MD) at 150° C. is less than 10%;
(4) a coating layer porosity of the coating layer is between 45% and 55%;
(5) a Gurley value (sec/10 cc air) of the separator is between 10 and 20; and
(6) a thermal cell closure temperature of the separator is above 150° C.

9. A method for manufacturing a separator, comprising:
providing a substrate layer, wherein the substrate layer is a polyolefin porous film and has a substrate thickness ranging from 10 to 30 micrometers;
disposing a coating liquid composition, wherein the coating liquid composition includes a solute component and a solvent component, and a weight ratio of the solute component to the solvent component is between 2˜20:98˜80; wherein the solute component includes a heat-resistant resin material and a plurality of inorganic ceramic particles;
coating the coating liquid composition on a side surface of the substrate layer; and
removing the solvent component in the coating liquid composition, so that the coating liquid composition is formed as a coating layer, wherein a coating layer thickness of the coating layer ranges from 1 micron to 5 microns;
wherein the substrate layer and the coating layer jointly form a separator; in the coating layer, the heat-resistant resin material has a melting point of not less than 150° C. or a glass transition temperature of not less than 100° C., an average particle size of the inorganic ceramic particles is 10% to 40% of the coating layer thickness of the coating layer, and the inorganic ceramic particles are stacked in the coating layer with a height of at least three layers.
